(19) United States
(12) Patent Application Publication
(10) Pub. No.: US 2024/0172187 A1
(43) Pub. Date: May 23, 2024

(54) MANAGING RESOURCE CONFLICT IN DIRECT TRANSMISSIONS BETWEEN USER EQUIPMENT

(71) Applicant: Nokia Technologies Oy, Espoo (FI)

(72) Inventors: Prajwal KESHAVAMURTHY, Munich (DE); Nuno Manuel KIILERICH PRATAS, Gistrup (DK); Lianghai JI, Aalborg (DK); Daniel MEDINA, Munich (DE)

(73) Assignee: Nokia Technologies Oy, Espoo (FI)

(21) Appl. No.: 18/283,638

(22) PCT Filed: Jan. 20, 2022
(86) PCT No.: PCT/EP2022/051162

§ 371 Date: Sep. 22, 2023

(30) Foreign Application Priority Data
Mar. 24, 2021 (FI) 20215335

(51) Int. Cl. H04W 72/04

(52) U.S. Cl. CPC H04W 72/04

(57) ABSTRACT

An assistance user equipment is disclosed that is able to generate assistance information indicative of a resource conflict detected in a direct transmission between user equipment. The assistance user equipment comprises determining means for determining whether or not to provide the assistance information.

### TECHNOLOGICAL FIELD

Various example embodiments relate to managing resource conflict in direct transmissions between user equipment.

### BACKGROUND

User equipment (UE) may communicate directly with each other, in some cases using sidelink channels. A potential problem with such communications may arise when there is no central network control of resource allocation as in this case the UE autonomously selects its transmission resource, and there may be resource conflict which can lead to loss of data.

In this regard there is a half-duplex limitation on user equipment which means that user equipment that are transmitting are not listening for an incoming transmission. Thus, were a transmitting UE to select a resource for transmitting to a receiving UE and this resource overlapped in time with a resource that the receiving UE is using for transmitting itself, then not only does the receiving UE not receive the transmission but it is unaware that it has happened and thus, does not indicate to the transmitting UE that there is a problem. This potential for resource conflict leads to decreased reliability in direct communications.

### BRIEF SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to various, but not necessarily all, embodiments of the invention there is provided an apparatus, comprising: means for generating assistance information indicative of a resource conflict detected for a direct transmission from a user equipment; and determining means for determining whether or not to provide said assistance information.

In some example embodiments, said determining means is configured to determine whether or not to provide said assistance information in dependence upon at least one of: a determined density of user equipment in a surrounding area; a determined number of user equipment in a surrounding area; a determined received signal power at said apparatus from at least one of said user equipment in a surrounding area; a determined distance of said apparatus from at least one of said user equipment; and a determined communication activity level of said apparatus.

In some example embodiments, said determining means is configured to map at least one of said determined density, number, received power, distance or communication activity level to a probability of providing said assistance information, and to provide or not said assistance information in dependence upon said probability.

In some example embodiments, said determining means is configured to determine a probability value to map said at least one of said determined density, number, received power, distance or determined communication activity level to in dependence upon at least one of: probability mappings generated at said user equipment; preconfigured probability mappings stored within said user equipment; probability mappings provided to said user equipment by another user equipment; and probability mappings provided to said user equipment by a communication network.

According to various, but not necessarily all, embodiments of the invention there is provided an apparatus, comprising: means for generating assistance information indicative of a resource conflict detected for a direct transmission from a user equipment; and determining means for determining whether or not to provide said assistance information, wherein said determining means is configured to determine whether or not to provide said assistance information in dependence upon at least one of: a determined density of user equipment in a surrounding area; a determined number of user equipment in a surrounding area; and a determined communication activity level of said apparatus.

In some example embodiments, said determining means is configured to map at least one of said determined density, number, or communication activity level to a probability of providing said assistance information, and to provide or not said assistance information in dependence upon said probability.

In some example embodiments, said determining means is configured to determine a probability value to map said at least one of said determined density, number or determined communication activity level to in dependence upon at least one of: probability mappings generated at said user equipment; preconfigured probability mappings stored within said user equipment; probability mappings provided to said user equipment by another user equipment; and probability mappings provided to said user equipment by a communication network.

In some example embodiments, said determining means is configured following said determining of whether or not to provide said assistance information to determine: whether other user equipment transmitted said assistance information and to update said probability mappings accordingly.

In some example embodiments, said determining means is configured following determining not to provide said assistance information for a detected resource conflict to determine whether said user equipment have resolved said detected resource conflict and where not to update said probability mapping for at least one of: providing said assistance information for said detected resource conflict and providing assistance information for a future detected conflict.

In some example embodiments, said determining means is configured to determine a number or density of user equipment in said surrounding area by at least one of: a sidelink channel busy ratio CBR; a number of detected transmissions; a number of physical sidelink feedback channel PSFCH occupied resources; a number of detected post-collision indications; or a number of detected transmitting and receiving user equipment pairs within a surrounding area.

In some example embodiments, said apparatus further comprises: means for detecting a resource conflict.

In some example embodiments, in response to said means for detecting a resource conflict detecting multiple conflicts in a same resource, said determining means is configured to determine whether or not to provide said assistance information for each of said detected conflicts.

In some example embodiments, in response to said determining means determining to provide said assistance information to a plurality of user equipment, said apparatus is configured to multiplex a plurality of said assistance information into one message, said one message being transmitted by broadcasting or groupcasting said one message.

In some example embodiments, said means for detecting a resource conflict is configured to detect at least one of: reservations of resources for future transmissions, and to determine said resource conflict in response to detecting overlapping reservations; a transmitting user equipment transmitting to a receiving user equipment that is itself currently transmitting.

In some example embodiments, said determining means is responsive to a stop determining indication received from a communication network to stop determining whether or not to provide said assistance information and is further responsive to a start determining indication to restart determining whether to provide said assistance information or not.

In some example embodiments, said means for generating assistance information is configured to generate said assistance information to indicate at least one of: a collision; a collision and the conflicted resource; a potential collision; and a potential collision and the conflicted resource.

In some example embodiments, said means for generating assistance information is configured to generate said assistance information as a NACK negative acknowledgement signal and said apparatus is configured to output said NACK signal on a PSFCH a physical sidelink feedback channel.

In some example embodiments, said apparatus comprises a user equipment.

In some example embodiments, said means for generating assistance information, said determining means and said means for detecting a resource conflict comprise: at least one processor; and at least one memory including computer program code, the at least one memory and computer program code being configured to, with the at least one processor, cause the performance of the apparatus.

According to various, but not necessarily all, embodiments of the invention there is provided according to a further aspect, a method comprising: in response to an indication that a resource conflict has been detected for a direct transmission from a user equipment; determining whether or not to provide assistance information indicative of said detected resource conflict.

In some example embodiments, said determining whether or not to provide assistance information indicative of said detected resource conflict is performed in dependence upon at least one of: a determined density of user equipment in a surrounding area; a determined number of user equipment in a surrounding area; a determined received signal power at said apparatus from at least one of said user equipment in a surrounding area; a determined distance of said apparatus from at least one of said user equipment; and a determined communication activity level of said apparatus.

In some example embodiments, said determining comprises mapping at least one of said determined density, number, received power, distance or communication activity level to a probability of providing said assistance information, and to provide or not said assistance information in dependence upon said probability.

In some example embodiments, said determining comprises determining a probability value to map said at least one of said determined density, number, received power, distance or determined communication activity level to in dependence upon at least one of: probability mappings generated at said user equipment; preconfigured probability mappings stored within said user equipment; probability mappings provided to said user equipment by another user equipment; and probability mappings provided to said user equipment by a communication network.

According to various, but not necessarily all, embodiments of the invention there is provided according to a second aspect, a method comprising: in response to an indication that a resource conflict has been detected for a direct transmission from a user equipment; determining whether or not to provide assistance information indicative of said detected resource conflict in dependence upon at least one of: a determined density of user equipment in a surrounding area; a determined number of user equipment in a surrounding area; and a determined communication activity level of said apparatus.

In some example embodiments, said method further comprises: generating said assistance information.

In some example embodiments, said determining comprises mapping at least one of said determined density, number, or communication activity level to a probability of providing said assistance information, and to provide or not said assistance information in dependence upon said probability.

In some example embodiments, said determining comprises determining a probability value to map said at least one of said determined density, number, or determined communication activity level to in dependence upon at least one of: probability mappings generated at said user equipment; preconfigured probability mappings stored within said user equipment; probability mappings provided to said user equipment by another user equipment; and probability mappings provided to said user equipment by a communication network.

In some example embodiments, said method comprises after determining whether or not to provide said assistance information determining whether other user equipment transmitted said assistance information and updating said probability mappings accordingly.

In some example embodiments, said method comprises after determining not to provide said assistance information for a detected resource conflict determining whether said user equipment have resolved said detected resource conflict and where not updating said probability mapping for at least one of: providing said assistance information for said detected resource conflict and providing assistance information for a future detected conflict.

In some example embodiments, said method comprises determining a number or density of user equipment in said surrounding area by at least one of: a sidelink channel busy ratio CBR; a number of detected transmissions; a number of physical sidelink feedback channel PSFCH occupied resources; a number of detected post-collision indications; or a number of detected transmitting and receiving user equipment pairs within a surrounding area.

In some example embodiments, said method further comprises: detecting a resource conflict.

In some example embodiments, in response to detecting multiple conflicts in a same resource, said method determines whether or not to provide said assistance information for each of said detected conflicts.

In some example embodiments, in response to determining to provide said assistance information to a plurality of user equipment, said method multiplexes a plurality of said assistance information into one message and transmits said one message by broadcasting or groupcasting said one message.

In some example embodiments, said method detects a resource conflict by at least one of detecting: reservations of resources for future transmissions, and determining said resource conflict in response to detecting overlapping reservations; a transmitting user equipment transmitting to a receiving user equipment that is itself currently transmitting.

In some example embodiments, said method is responsive to a stop determining indication received from a communication network to stop determining whether or not to provide said assistance information and is further responsive to a start determining indication to restart determining whether to provide said assistance information or not.

In some example embodiments, said method generates said assistance information to indicate at least one of: a collision; a collision and the conflicted resource; a potential collision; and a potential collision and the conflicted resource.

In some example embodiments, method generates said assistance information as a NACK signal and said apparatus is configured to output said NACK signal on a PSFCH a physical sidelink feedback channel.

According to various, but not necessarily all, embodiments of the invention there is provided a computer program comprising computer readable instructions which when executed by a processor are operable to control said processor: in response to an indication that a resource conflict has been detected for a direct transmission from a user equipment, to determine whether or not to provide assistance information indicative of said detected resource conflict.

According to various, but not necessarily all, embodiments of the invention there is provided a computer program comprising computer readable instructions which when executed by a processor are operable to control said processor: in response to an indication that a resource conflict has been detected for a direct transmission from a user equipment, to determine whether or not to provide assistance information indicative of said detected resource conflict in dependence upon at least one of: a determined density of user equipment in a surrounding area; a determined number of user equipment in a surrounding area; and a determined communication activity level of said apparatus.

According to various, but not necessarily all, embodiments of the invention there is provided a network node configured to generate a user equipment assistance information control signal, said assistance information control signal comprising an indication as to whether a user equipment should determine whether or not to provide assistance information indicative of a detected resource conflict.

In some example embodiments the assistance information control signal comprises a stop determining indication indicating said user equipment should stop determining whether to provide said assistance information or not.

In some example embodiments the assistance information control signal comprises a start determining indication indicating said user equipment should start determining whether to provide said assistance information or not.

According to various, but not necessarily all, embodiments of the invention there is provided a network node configured to generate a user equipment assistance information control signal, said assistance information control signal comprising probability mappings providing a probability of providing assistance information in dependence upon at least one of: a density of other user equipment in a surrounding area; a number of user equipment in a surrounding area; a distance between said user equipment and a user equipment determined to have a resource conflict; a received signal power from at least one of said user equipment in a surrounding area and a determined communication activity level of said user equipment.

In some example embodiments, the network node is a gNodeB or an application server.

In some example embodiments, the assistance information control signal is output in a system information block or in a dedicated radio resource control RRC signal.

According to various, but not necessarily all, embodiments of the invention there is provided according to a third aspect a method for generating a user equipment assistance information control signal, said assistance information control signal comprising an indication as to whether a user equipment should determine whether or not to provide assistance information indicative of a detected resource conflict.

According to various, but not necessarily all, embodiments of the invention there is provided according to a fourth aspect a method for generating a user equipment assistance information control signal, said assistance information control signal comprising probability mappings providing a probability of providing assistance information in dependence upon at least one of: a determined density of user equipment in a surrounding area; a determined number of user equipment in a surrounding area; a determined received signal power at said apparatus from at least one of said user equipment in a surrounding area; a determined distance of said apparatus from at least one of said user equipment; and a determined communication activity level of said apparatus.

According to various, but not necessarily all, embodiments of the invention there is provided a computer program comprising computer readable instructions which when executed by a processor are operable to control said processor to perform a method according to a second, third or fourth aspect.

According to various, but not necessarily all, embodiments of the invention there is provided an apparatus, comprising: circuitry configured to generate assistance information indicative of a resource conflict detected for a direct transmission from a user equipment; and determining circuitry configured to determine whether or not to provide said assistance information.

In some example embodiments, said determining circuitry is configured to determine whether or not to provide said assistance information in dependence upon at least one of: a determined density of user equipment in a surrounding area; a determined number of user equipment in a surrounding area; a determined received signal power at said apparatus from at least one of said user equipment in a surrounding area; a determined distance of said apparatus from at least one of said user equipment; and a determined communication activity level of said apparatus.

In some example embodiments, said determining circuitry is configured to map at least one of said determined density, number, received power distance or communication activity level to a probability of providing said assistance information, and to provide or not said assistance information in dependence upon said probability.

In some example embodiments, said determining circuitry is configured to determine a probability value to map said at least one of said determined density, number, received power, distance or determined communication activity level to in dependence upon at least one of: probability mappings generated at said user equipment; preconfigured probability mappings stored within said user equipment; probability mappings provided to said user equipment by another user equipment; and probability mappings provided to said user equipment by a communication network.

In some example embodiments, said determining circuitry is configured following said determining of whether or not to provide said assistance information to determine: whether other user equipment transmitted said assistance information and to update said probability mappings accordingly.

In some example embodiments, said determining circuitry is configured following determining not to provide said assistance information for a detected resource conflict to determine whether said user equipment have resolved said detected resource conflict and where not to update said probability mapping for at least one of: providing said assistance information for said detected resource conflict and providing assistance information for a future detected conflict.

In some example embodiments, said determining circuitry is configured to determine a number or density of user equipment in said surrounding area by at least one of: a sidelink channel busy ratio CBR; a number of detected transmissions; a number of physical sidelink feedback channel PSFCH occupied resources; a number of detected post-collision indications; or a number of detected transmitting and receiving user equipment pairs within a surrounding area.

In some example embodiments, said apparatus further comprises: circuitry configured to detect a resource conflict.

In some example embodiments, in response to said circuitry configured to detect a resource conflict detecting multiple conflicts in a same resource, said circuitry for determining is configured to determine whether or not to provide said assistance information for each of said detected conflicts.

In some example embodiments, in response to said determining circuitry determining to provide said assistance information to a plurality of user equipment, said apparatus is configured to multiplex a plurality of said assistance information into one message, said one message being transmitted by broadcasting or groupcasting said one message.

In some example embodiments, said circuitry configured to detect a resource conflict is configured to detect at least one of: reservations of resources for future transmissions, and to determine said resource conflict in response to detecting overlapping reservations; a transmitting user equipment transmitting to a receiving user equipment that is itself currently transmitting.

In some example embodiments, said determining circuitry is responsive to a stop determining indication received from a communication network to stop determining whether or not to provide said assistance information and is further responsive to a start determining indication to restart determining whether to provide said assistance information or not.

In some example embodiments, said for circuitry configured to generate assistance information is configured to generate said assistance information to indicate at least one of: a collision; a collision and the conflicted resource; a potential collision; and a potential collision and the conflicted resource.

In some example embodiments, said circuitry configured to generate assistance information is configured to generate said assistance information as a NACK signal and said apparatus is configured to output said NACK signal on a PSFCH a physical sidelink feedback channel.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

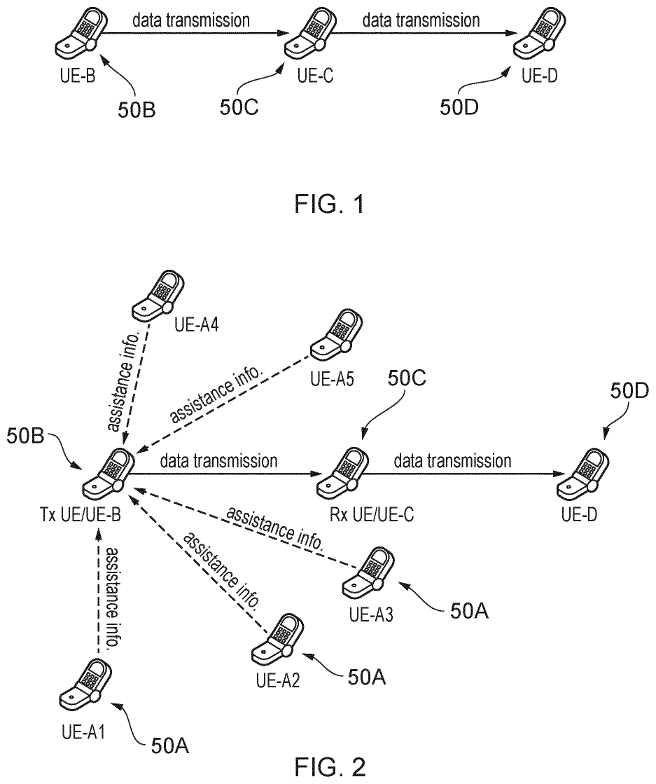

FIG. 1 illustrates the direct transmission of signals between user equipment;

FIG. 2 illustrates the provision of assistance information to user equipment directly transmitting signals

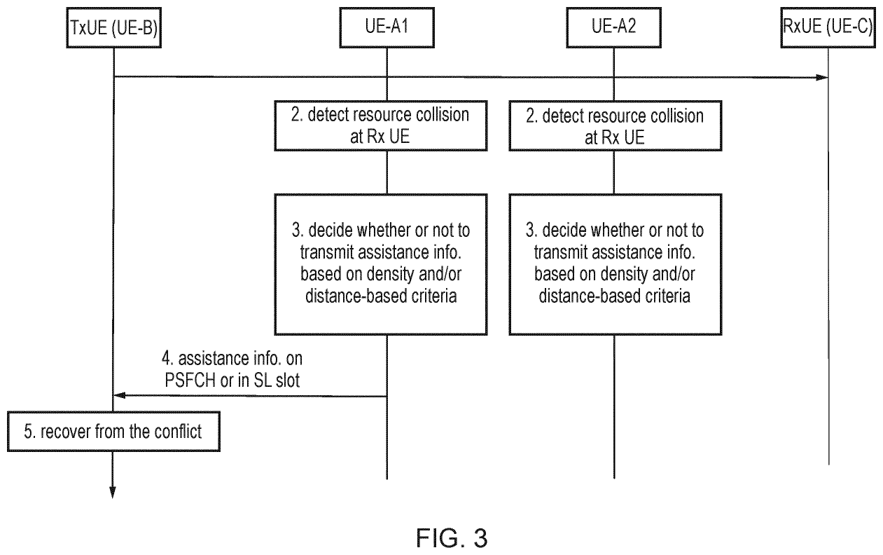

FIG. 3 illustrates an example embodiment of the determination of whether or not to transmit assistance information;

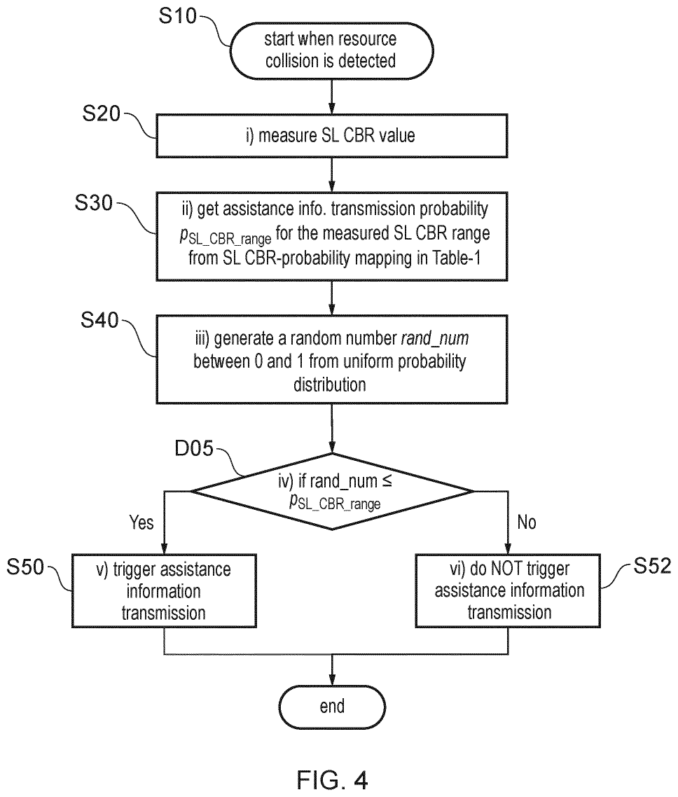

FIG. 4 illustrates a flow chart showing a method of determining whether or not to transmit assistance information according to an example embodiment;

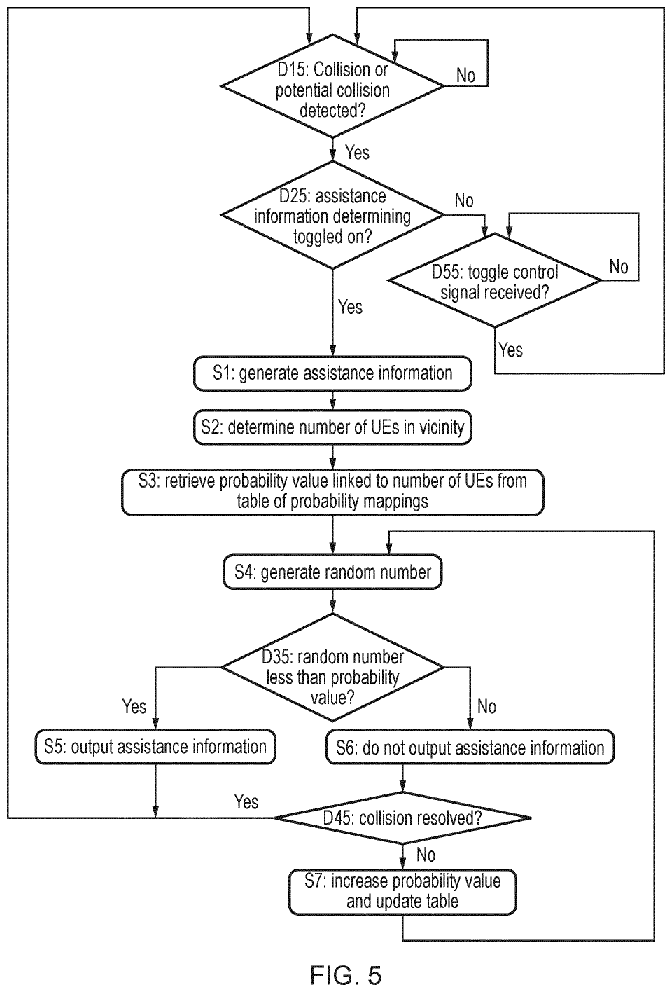

FIG. 5 illustrates a flow chart showing a further method of determining whether or not to transmit assistance information according to an example embodiment; and

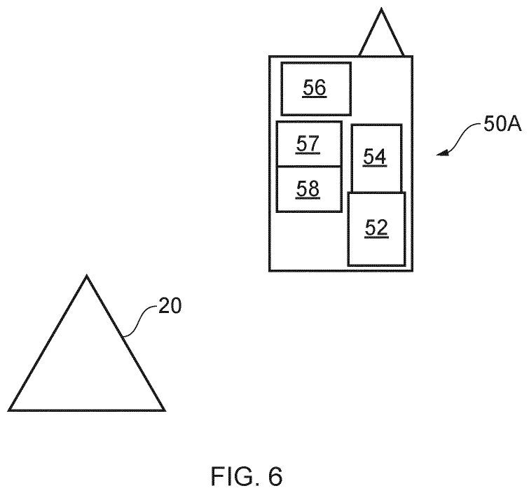

FIG. 6 illustrates a user equipment and a network node according to an example embodiment.

### DETAILED DESCRIPTION

Before discussing the example embodiments in any more detail, first an overview will be provided.

Example embodiments seek to improve the reliability of direct transmissions between user equipment by notifying user equipment of resource conflicts, and thereby enabling retransmission or avoidance of using the conflicted resources, using assistance user equipment that are not themselves involved in the direct communication but are able to detect conflicts occurring in neighbouring user equipment. These assistance user equipment can then assist the user equipment by providing assistance information indicating that the conflict has occurred. This information may be provided directly to one of the user equipment and/or it may be provided to the network and/or to another user equipment such as a scheduling user equipment.

However, it was recognised that there is an overhead associated with transmitting this information and that in some circumstances it may be preferable not to provide the assistance information, thus, example embodiments seek to reduce this overhead by seeking to provide the assistance information only in situations where the transmission of this information is likely to improve performance. The circumstances where transmitting the assistance information is more likely to be an overhead than an advantage include circumstances where there is a large number/density of user equipment in the surrounding area and/or where a determined communication activity of the assistance user equipment is at a high level.

It should be noted that where it is determined not to provide assistance information then this assistance information may not be generated or it may be generated but not output. In some embodiments, the generated assistance information that is not output may be output later, when it is determined that the detected conflict or potential has not been resolved by other means.

When determining whether or not to provide the assistance information, one or more factors may contribute to the decision. For example, where there are many user equipment in the surrounding area then there is a reduced probability that outputting the assistance information will improve performance as it is likely that at least one other of the many user equipment may also be aware of the conflict or potential conflict and may itself transmit assistance information. Clearly it is advantageous if at least one user equipment transmits the assistance information but there is no requirement for more than one. Thus, embodiments seek to keep the number of user equipment transmitting assistance information at or close to one and they may do so by determining whether or not to transmit the assistance information in dependence upon the density or number of user equipment in the surrounding area. The higher the density the more probable it is that another user equipment will be transmitting the assistance information and therefore, in some embodiments where there is a high number of other user equipment a reduced probability value is provided to the user equipment, and this reduced probability value is used to determine whether the assistance information is output or not. The conversion of the probability to a binary decision can be done in a number of ways. In one embodiment it is done by generating a random number between 0 and 1 and comparing it with the probability. Where the random number is lower than the probability then assistance information is provided. Thus, the lower the probability value the less likely it is that the decision will be to output the assistance information.

Where the assistance user equipment is itself currently actively communicating by receiving and/or transmitting signals, it is itself vulnerable to the half duplex receiving problem if it transmits further information in the form of assistance information and thus, where it is determined that its activity level is high then it may be given a reduced probability to provide the assistance information so that a user equipment that is currently less active will be preferentially selected.

Another factor that may be used in determining whether or not a particular user equipment provides the assistance information may be the distance from the user equipment involved in the resource conflict. That is, where the user equipment are more distanced then a lower probability may be given.

The received signal power may also be used as a factor in determining whether or not a particular user equipment provides the assistance information. Where it is the power of the signal from one of the conflicted UEs, then the lower the power the lower the probability given, as low power indicates the conflicted UE may be at some distance.

The received signal power from multiple surrounding UEs may also be used as a factor in determining whether or not a particular user equipment provides the assistance information. In this case, the higher the cumulative power the lower the probability as a higher power may be indicative of many UEs in the vicinity.

The probability may be determined from probability mappings which map particular numbers, densities, signal powers, distances or communication activity levels to particular probabilities. These mappings may be provided by the communication network where there is coverage for the UE in the form of a control signal or they may be provided from another user equipment in the neighbourhood, or they may be in a preconfigured data store within the user equipment, and/or they may be generated or updated at the user equipment. Where the probability mappings are generated or updated at the user equipment they may be generated by learned behaviour whereby the user equipment determines when it makes a decision to transmit or not transmit whether or not assistance information is transmitted by another user equipment and adjusts its probabilities accordingly, so that where multiple versions of the assistance information is output the probability is reduced, while where none are output it may be increased.

The density of user equipment may be determined from the sidelink channel busy ratio CBR. Alternatively, the number of user equipment within an area may be determined from by detecting the PC5 links between transmitting and receiver user equipment pairs and determining the power, RSRP reference signal received power at the assistance UE for the associated transmissions and where it is greater than a threshold it is counted as within the area and where it is below it is counted as outside. In a similar way, distance can be detected from location information provided in the UE signalling or it may be derived from the strength of the RSRP detected.

The resource conflicts may be detected when they occur or they may be detected pre-collision by detecting the reservation of resources for future transmissions and determining where they overlap. In this regard the assistance user equipment may have a means for detecting the resource conflicts (current or potential) or the assistance user equipment may receive the resource conflict from another UE in the neighbourhood.

The assistance information may be transmitted in a number of forms, it may simply be indicative of a collision and in this case in some embodiments it may be a NACK signal sent on the PSFCH channel, while in other embodiments it may indicate the resource where the conflict occurred as well as that there has been or is likely to be a collision.

In some embodiments, the network may provide some control over whether or not the user equipment should determine whether or not to provide assistance information and this may be done in the form of control signalling provided in the SIB (system information block) or in dedicated RRC (radio resource control) signals. The signals may include a toggling signal that is configured to either activate the determining or deactivate it.

The following provides an example where embodiments may be used. Consider a scenario where UEs with half-duplex constraint operate in NR SL (sidelink) mode 2. Since UEs autonomously select SL transmission resources in NR SL mode 2, there may be packet loss at the intended receiving UE(s) due to half-duplex limitation when the receiving UE(s) is in the transmitting state (i.e. intended receiver is transmitting concurrently on SL). This causes degradation in SL reliability.

FIG. 1 illustrates an example scenario where UE-B 50B is transmitting to UE-C 50C and UE-C 50C is transmitting to UE-D 50D concurrently. Because UE-C 50C is transmitting to UE-D 50D, UE-C 50C does not listen to SL channel due to half-duplex limitation and therefore misses the packets transmitted concurrently from UE-B 50B. In another example, a transmit resource for transmission from UE-B 50B towards UE-C 50C (e.g. via SL broadcast, groupcast, and/or unicast) may overlap in the same SL time slot as a transmit resource for transmission from UE-C 50C towards UE-B 50B (e.g. via SL broadcast, groupcast, and/or unicast), which causes the considered half-duplex problem as well.

An assistance information such as the resources where the resource conflict due to e.g. half-duplex limitation is detected can be beneficial at the transmitting UEs TxUE(s) (e.g. UE-B 50B) since it enables them to perform retransmission and/or avoid using those conflicted resources for SL transmission to increase the SL reliability. But, with half-duplex limitation, the intended RxUE (e.g. UE-C in FIG. 1) cannot detect a resource conflict for transmission from TxUE (e.g. UE-B) since RxUE (e.g. UE-C) is not listening to SL transmission, and therefore it cannot provide any assistance information (e.g. resources where the resource conflict is detected) to TxUE (e.g. UE-B).

A third-party UE which is able to detect such a resource conflict can be considered as an assistant UE that provides the assistance information to the transmitter. This allows the transmitter UE to be aware of the (potential-)resource conflict from the third-party assistant UE and to take into account the resource in which the resource conflict is detected for increased reliability. However, any explicit and/or a prior inter-UE coordination between third-party assistant UE and the transmitter UE may introduce additional signaling overhead. In addition, there may be many UEs around TxUE which can act as an assistant UE. Therefore, transmission of assistance information from all those UEs to TxUE on the same detected resource conflict causes resource wastage because of assistance information redundancy at TxUE.

FIG. 2 illustrates such an example scenario where UEs UE-A1, UE-A2, . . . , UE-A5 detect resource conflict due to half-duplex limitation at RxUE UE-C for transmission from TxUE UE-B, and they transmit assistant information on the same detected resource conflict to TxUE UE-B causing resource wastage since transmission of assistance information from one UE, e.g. UE-A1, would have been sufficient. In addition, in general, multiple third-party UEs sending the assistance information leads the third-party UEs not able to receive SL concurrently due to the half-duplex constraint as well, which may cause other problems.

Assistance information, such as the resources where a resource conflict is detected (e.g., due to the half-duplex constraint), can be beneficial at a TxUE since it can then perform a retransmission and/or avoid using those conflicting resources for SL transmission, thus increasing the SL reliability. A third-party UE may detect such a resource conflict and therefore can provide assistance information, e.g., a notification on the resource conflict or the resources where the resource conflict is detected, to the TxUE. When there are many third-party UEs present around a TxUE, then many UEs may detect the same resource conflict. However, it may be sufficient if only one (or a few) of the third-party UEs acts as an assistant UE and provide assistance information to the TxUE.

Therefore, in order to provide assistance information from a third-party UE to the TxUE in a resource efficient manner, example embodiments provide UE density-based and distance-based criteria for triggering assistance information transmission, thereby inhibiting too many third-party UEs from providing the assistance information on the same resource conflict. Furthermore, in some example embodiments PSFCH resources associated with PSCCH/PSSCH resources are exploited to transmit assistance information on the PSCCH/PSSCH resource conflict to the TxUE.

The UE may detect the resource conflict in a number of ways and that is not important to the determination process of whether or not to transmit this assistance information. Thus, example embodiment are concerned primarily with situations where there are multiple assisting UEs (i.e. UEs that can take the role of UE-A) and how these UEs can decide whether or not to perform the conflict indication transmission based on criteria for which the goal is to reduce the number of transmitted conflict indication messages. In summary example embodiments seek to control congestion that might be induced by multiple UE-As transmitting the same conflict indication message related to the same conflict.

In order to support inter-UE coordination in a resource efficient manner for increased SL transmission reliability, the following example embodiments are proposed:
Upon detecting a resource conflict (e.g., a half-duplex conflict occurring at UE-C, due to UE-C and UE-B transmitting in the same slot, where the transmission from UE-B is intended for UE-C, while the transmission from UE-C may be intended for UE-B and/or UE-D), an assisting UE (UE-Ax) decides to transmit assistance information, e.g., notification/indication of the resource conflict or of the resources where the resource conflict is detected, to the TxUE according to a UE density-based and/or distance-based decision criterion, such that different UE-Axs may have different decisions on whether or not to transmit the assistance information. We note that this criterion should be such that with high probability at least one assisting UE transmits the assistance information, but at the same time the number of UEs transmitting the assistance information on the same detected resource conflict to TxUEs is reduced when compared to all of them transmitting this information.

Embodiment 1: A SL CBR-dependent probability is used at the UE (third-party UE) to decide whether or not to transmit assistance information. The measured SL CBR is mapped to a probability of assistance information transmission P_{assist,CBR} (SL_CBR) and the UE transmits assistance information with probability P_{assist,CBR} (SL_CBR) when the measured SL CBR is SL_CBR. For instance, the higher the measured SL CBR, the lower the probability with which the UE transmits the assistance information.

Embodiment 2: A probability dependent on a number of neighbor PC5 links within a certain range of the UE (or for which the RSRP measured at the UE for the associated transmission is above an RSRP threshold) is used at the UE to decide whether or not to transmit assistance information. The number of neighbour PC5 links sensed around the UE within a given range (or with RSRP above an RSRP threshold for the associated transmission) is mapped to a probability of assistance information transmission P_{assist,num} (num), and the UE transmits assistance information with probability P_{assist,num} (num) when numPC5 links are sensed around the UE. The higher the number of neighbour PC5 links, the lower the probability with which the UE transmits the assistance information.

Embodiment 3: A distance-dependent probability is used at the UE to decide whether or not to transmit assistance information. The range (distance) from the TxUE and/or RxUE is mapped to a probability of assistance information transmission P_{assist,range} (range), and the UE transmits assistance information with probability P_{assist,range} (range) when the UE is located at a range range from TxUE and/or RxUE. For instance, the farther the UE is from the TxUE and/or RxUE, the lower the probability with which the UE transmits the assistance information. Alternatively, instead of range, the assisting UE can utilize an RSRP from the TxUE and/or RxUE to derive the probability of assistance information transmission P_{assist,range} (RSRP). For instance, the lower the RSRP, the lower the probability with which the UE transmits the assistance information.

Embodiment 4: The assisting UE detects multiple transmissions in the conflicted resource; and performs the decision to indicate a conflict to each of the detected transmitters individually by applying all or some of the Embodiments 1, 2, 3, and/or 6 (see below). The indication to a specific transmitter can be done (for example) in the PSFCH resource associated with each transmitter. Optionally, the assisting UE may multiplex multiple assistance information messages for different transmitters into one message and broadcast/groupcast the message.

Embodiment 5: The mapping between SL_CBR and P_{assist,CBR}, number of neighbor UEs and P_{assist,num} and/or range and P_{assist,range} can be provided by the network via, e.g., RRC (Radio Resource Control) configuration, SIB, and/or as a pre-configuration and/or by another UE and/or the UE can create and maintain the mapping according to its surrounding environment. Additionally, the assistance information can be toggled (i.e. assistance information transmission based on Embodiments 1, 2, 3, and/or 6 can be enabled or disabled) by the network as part of the SL SIB configuration and/or RRC configuration.

Embodiment 6: The assisting UE may derive the probability for transmitting the assistance information based on its own communication activity. For example, if the assisting UE is to receive from many peer UEs or in a large percentage of time-domain resources based on its own estimation, e.g., due to interaction-intensive task(s), it may determine a low probability of assistance information transmission, in order to avoid the half-duplex problem at itself.

Embodiment 7: if the UE decides to NOT transmit the assistance information according to the derived probability, the UE may monitor if another UE transmits the assistance information and/or if the resource conflict is resolved by the TxUE, wherein the TxUE may resolve the resource conflict based on assistance information received from at least one other (third-party) UE, e.g., by performing a retransmission, reselecting a resource, pre-empting the reserved/conflicting resource, etc. If no other UE transmitted the assistance information and/or the resource conflict is not resolved by the TxUE, the UE may decide to use a new rule/function to derive the probability of assistance information transmission (e.g., increasing the probability by a configured offset), wherein the new rule/function can be used for the current and/or future detected resource conflict (e.g., for a configured period of time).

In summary, in order to send assistance information to a TxUE regarding a resource conflict at RxUE for a sidelink transmission of PSCCH/PSSCH from the TxUE, a (third-party) UE may use the PSFCH resource(s) associated with the PSCCH/PSSCH resources, wherein the above embodiments are used to derive the probability for the third-party UE to determine whether or not to transmit over the PSFCH resource(s).

This eliminates or at least reduces the need for additional resources for assistance information transmission, as well as addressing the half-duplex problem at the third-party UEs where the third party UE decides not to transmit the assistance information over the PSFCH resource(s).

FIG. 3 shows a message sequence chart according to an embodiment. Third-party UEs UE-A1 and UE-A2 detect the resource conflict, but because of the density and/or distance dependent criteria employed at third-party UEs for triggering assistance information transmission, only UE-A1 transmits the assistance information indicating the resource conflict to the TxUE (UE-B) (e.g. as result of the evaluation of its criteria) over PSFCH or utilizing a SL slot (e.g. a MAC CE).

The TxUE (UE-B) is performing a SL transmission to RxUE (UE-C) with HARQ feedback enabled. As an example, TxUE (UE-B) is considered to perform a unicast transmission to the RxUE (UE-C) over SL with HARQ feedback enabled. The third-party UEs (UE-A1 and UE-A2) are monitoring the SL resource pool and are able to sense the SL transmission from the TxUE to the RxUE. It is noted that the third-party UEs can also sense any SL transmission that may originate from the RxUE (where the third-party UE is aware of the RxUE different IDs).

UE-A1 and UE-A2 detect the resource conflict (e.g., a half-duplex conflict occurring at UE-C due to UE-C and UE-B transmitting in the same slot, where the transmission from UE-B is intended for UE-C, while the transmission from UE-C may be intended for UE-B or UE-D). Such resource conflict detection is possible at UE-A1 and UE-A2 since they are sensing the SL resource pool (i.e., UE-A1 and UE-A2 are at least decoding the 1st and 2nd stage SCI) and therefore can detect that the transmission from UE-B is intended for UE-C.

In an example implementation, the resource conflict can be detected at UE-A1 and UE-A2 due to the destination ID in the 2nd stage SCI of UE-B's transmission matching the ID of UE-C. UE-A1 and UE-A2 can be aware of UE-C's ID based on their monitoring of the SL resource pool, where they detected a past transmission from UE-C and from that acquired UE-C's ID; or due to the source ID in UE-C's transmission matching the destination ID in UE-B's transmission.

In another example implementation, the resource conflict is detected at UE-A1 and UE-A2 based on the overlapping of the resources used in the transmissions of UE-B and UE-C.

It is noted, that the method of detecting the resource conflict is immaterial to the decision as to whether or not to transmit assistance information.

Upon detection of the resource conflict (step 2), UE-A1 and UE-A2 decide whether or not to transmit the assistance information, e.g., a notification on the resource conflict or the resources where the resource conflict is detected, to the transmitting UEs (UE-B and UE-C). The decisions may be made based on UE density-based and/or distance-based criteria and the criteria may be the same or different at each UE. These criteria dictate the probability with which the assistance information is transmitted from the third-party UEs (UE-A1 and UE-A2) to the transmitting UEs.

In the case of density-dependent probability criteria for SL assistance information transmission: where there is a higher UE density, it is very likely that there will be other candidate third-party assistance UEs, whereas under lower UE density, third-party UEs which can transmit assistance information are likely to be fewer. Hence, to inhibit too many UEs from transmitting the assistance information regarding the same resource conflict, a probability that depends on UE density can be used to trigger assistance information transmission. The third-party UE is provided with a higher probability to transmit assistance information when there are fewer UEs around, while when the UE density is higher (i.e., when there are more UEs in the vicinity), the third-party UE is provided with a lower probability to reduce the likelihood of multiple UEs transmitting the same assistance information to the TxUE.

(Embodiment 1) SL CBR-dependent probability criterion for SL assistance information transmission trigger:
SL CBR can be a good measure of UE density since, e.g., higher UE density may result in higher SL channel occupancy, which causes higher SL CBR. Therefore, a SL CBR-dependent probability criterion is proposed at the third-party UE to decide whether or not to transmit assistance information to the TxUE. The measured SL CBR is mapped to a probability of assistance information transmission P_{assist,CBR} (SL_CBR) and the UE transmits assistance information with probability P_{assist,CBR} (SL_CBR)when the measured SL CBR is SL_CBR. For instance, the higher the measured SL CBR, the lower the probability with which UE transmits the assistance information.

The mapping between SL CBR and the probability with which the third-party UE transmits the assistance information P_{assist,CBR} (SL_CBR)is either created and maintained at the third-party UE, provided to the UE by a neighbouring UE, or provided to the UE by the network via, e.g., RRC configuration or received as pre-configuration. An example of such a mapping is given in table 1:

TABLE 1
Example mapping between SL CBR and assistance
information transmission probability

| SL CBR | Assistance information |
|---|---|
| value ranges | transmission probability |
| (SL_CBR_range) | (p_{assist, CBR} (SL_CBR_range)) |
| SL_CBR_range_1 | p_{SL}_{_{—}}_{CBR}_{_{—}}_{range}_{_{—}}₁ |
| SL_CBR_range_2 | p_{SL}_{_{—}}_{CBR}_{_{—}}_{range}_{_{—}}₂ |
| SL_CBR_range_3 | p_{SL}_{_{—}}_{CBR}_{_{—}}_{range}_{_{—}}₃ |
| . | . |
| . | . |
| . | . |
| SL_CBR_range_N | p_{SL}_{_{—}}_{CBR}_{_{—}}_{range}_{_{—}}_{N} |

A flowchart for an example implementation is illustrated in FIG. 4. Upon detection of a resource conflict at step S10 which, e.g., may cause packet loss due to the half-duplex constraint at the intended RxUE, the third-party UE performs the following steps:
S20—UE measures the SL CBR value as defined in 3GPP TS 38.215 (section 5.1.27). Let SL_CBR be the measured SL CBR value. The CBR is an indication of the number or density of user equipment in the surrounding area.
S30—For the measured SL CBR, a SL CBR range SL_CBR_range in Table 1 within which the SL_CBR falls is identified. For the SL_CBR_range from the SL CBR-probability mapping in Table 1, a probability of assistance information transmission P_{SL_CBR_range} is identified.

S40—A random number rand_num is generated between 0 and 1 from a uniformly distributed random number generator.

D05—The random number generated in Step iii is compared with the probability value P_{SL_CBR_range} in Step ii.

If rand_num≤P_{SL_CBR_range} in Step iv,

S50—the third-party UE triggers assistance information transmission to the TxUE, else S52—If rand_num>p_{SL_CBR_range} in Step iv, the third-party UE does not trigger assistance information transmission to the TxUE.

(Embodiment 2) Number of neighbour PC5 links (within certain range) is the dependent probability criterion for SL assistance information transmission trigger: Alternatively, or additionally to SL CBR-dependent probability criterion, a probability dependent on a number of neighbour PC5 links (within a certain range) can be used as a criterion at the UE to decide whether or not to transmit assistance information. The number of neighbor PC5 links sensed around the UE within a given range can be mapped to a probability of assistance information transmission P_{assist,num} (num), and the UE transmits assistance information with probability P_{assist,num} (num) when numPC5 links are sensed around the UE. A UE can identify the presence of neighbor PC5 links by reading the SCI (source ID and destination ID pair) originating from the neighbor UEs. For instance, the higher the number of neighbour PC5 links around the UE, the lower the probability with which the UE transmits the assistance information.

The mapping between the number of neighbour PC5 links and the probability with which the third-party UE transmits the assistance information p_{assist,num} (num) is either created and maintained at the third-party UE or provided to the UE by the network via, e.g., RRC configuration or received as pre-configuration, or provide to the UE by another UE. It is noted that the table/format for mapping between ranges of number of neighbour PC5 links and probability can be similar to Table 1. Furthermore, an example implementation can be similar to FIG. 4, where UE density range for the measured number of neighbour PC5 links can be used instead of SL CBR.

(Embodiment 3) Distance-dependent probability criterion for SL assistance information transmission trigger: Alternatively, or additionally, a distance-dependent probability can be used as a criterion at the UE to decide whether or not to transmit assistance information. The range (distance) from the TxUE and/or RxUE is mapped to a probability of assistance information transmission P_{assist,range} (range), and the UE transmits assistance information with probability P_{assist,range} (range) when the UE is located at a range range from the TxUE and/or RxUE. For instance, the further the UE is from the TxUE and/or RxUE, the lower the probability with which UE transmits the assistance information.

The mapping between range (distance) and the probability with which the third-party UE transmits the assistance information is either created and maintained at the third-party UE or provided to the UE by the network via, e.g., RRC configuration or received as pre-configuration, or provided to the UE by another UE. It is noted that the table/format for mapping between range (distance) and probability can be similar to Table 1. Furthermore, an example implementation can be similar to FIG. 4, where range (distance) at which the UE is located can be used instead of SL CBR.

(Embodiment 6): Own communication activity dependent criterion for SL assistance information transmission trigger: The assisting UE may derive the probability for transmitting the assistance information based on its own communication activity. For example, if the assisting UE has to receive from many peer UEs or in a large percentage of time-domain resources based on its own estimation, e.g., due to interaction-intensive task(s), it may determine a low probability of assistance information transmission, in order to avoid or at least reduce the half-duplex problem at itself.

(Embodiment 4) The third-party UE, when detecting multiple transmitters in the resource conflict may decide which of the transmitters to provide the assistance information to based on any one of embodiments 1, 2, 3 and/or 6. The indication to a specific transmitter can be done (for example) in the PSFCH resource associated with each transmitter.

If UE-A1 decides to trigger assistance information transmission and UE-A2 decides not to transmit assistance information in Step 3, only UE-A1 transmits the assistance information on the resource conflict (e.g., a notification on the resource conflict or the resources where the resource conflict is detected) to the transmitting UEs (UE-B and UE-C).

To send the assistance information to the transmitting UEs on the resource conflict, UE-A1 may use the PSFCH resources associated with the original PSCCH/PSSCH transmission of each transmitter. This eliminates the need for additional resources for assistance information transmission.

In case UE-A1 is unable to transmit in the PSFCH resource associated with the detected conflict, then UE-A1 can instead transmit in another slot a MAC CE indicating the detected resource conflict. This approach is also applicable for transmissions where HARQ feedback is not required.

The transmitting UE (UE-B in the example in FIG. 3) receives the resource conflict indication and then can decide whether or not to perform a retransmission in another resource.

Alternatively, and for the case of periodic (i.e., SPS) transmission, upon receiving the assistance information from the third-party UE, UE-B can make use of the assistance information to trigger a resource pre-emption at the next transmit opportunity in which the periodic (SPS) transmission would take place. In this way, for example, if UE-A1 or UE-A2 are not coordinating with UE-C, the resource pre-emption triggered by UE-B triggers in turn a resource re-evaluation at UE-C, thus preventing the resource conflict from occurring again. For this case, UE-B might have to increase the priority of its transmission in order to trigger the resource re-evaluation at UE-C.

FIG. 5 shows a further flow diagram illustrating steps in a method according to an example embodiment.

In this example an assistant user equipment according to an example embodiment detects collisions or potential collisions between neighbouring user equipment that are directly communicating with each other. If a collision or potential future collision is detected at step D15 the user equipment will determine whether its assistance information determining function is currently toggled on or off. If it is toggled on then at step S1 it will generate assistance information.

If it is determined to be toggled off at step D25 then no assistance information will be generated until at step D55 a toggle control signal is received. At this point the assistant UE will toggle to assistance information determining on and proceed to step D15 where it will monitor for collisions.

Following the generation of assistance information at step S1, step S2 is performed where the number of UEs in the vicinity is determined. Then at step S3 a probability value is retrieved from a table of probability mappings that links the number of UEs in the surroundings to a probability value that determines the likelihood of the UE outputting the assistance information. At step S4 the UE generates a random number and determines at step D35 whether the random number is less than the probability value or not. If it is less than the probability value then it will output the assistance information at step S5 while if it is not, it will not output the assistance information at step S6. It should be noted that the steps of S4 and D35 are simply one way of converting a probability value to a binary decision of output or not, the likelihood of the decision being one way or the other depending on the probability. Other known ways of converting a probability value to a decision can be used. It should also be noted that step S1 for generating the assistance information may be performed after D35 and before S5 in some embodiments, such that assistance information is only generated in response to the UE determining that it is to provide the assistance information.

If at step D35 it is decided not to provide the assistance information the UE will then proceed to perform step D45 to determine whether the detected collision has been resolved or not. The collision may be resolved if for example, another assistance UE has provided the transmitting user equipment experiencing the conflict with assistance information. If the collision has been resolved then the UE will return to monitoring for collisions at step D15. If it has not been resolved then it will increase the probability value and update the table of probability mappings at step S7. It will then generate another random number at step S4 and repeat the process at step D35 of determining if the random number is less than the new probability value. If it is not then it will not output the assistance information and it will determine again if the collision is resolved and if not it will again increase the probability value and update the table. If however the new probability value does turn out to be less than the random number then it will output the assistance information at step S5 and will return to monitoring if collisions or potential collisions are detected.

FIG. 6 schematically shows a UE 50A according to an example embodiment. This UE 50A comprises determining circuitry 52 for determining whether or not assistance information should be provided. It also comprises assistance generating circuitry 54 for generating this assistance information. In this embodiment, user equipment 50A also comprises conflict detection circuitry 56 for detecting potential or actual conflicts and a data store 57 for storing a table of probability mappings mapping a probability of outputting the assistance information to one or more of the determining factors such as neighbouring UE density perhaps reflected in CBR values, current communication activity level of UE 50A, and distance from one of the conflicted UEs. It should be noted that in some embodiments the data store 57 stores multiple probability mappings that may be combined, such that a probability value relating to a density of UEs may be combined with a probability value relating to communication activity to provide a resultant probability on which the decision is made. There is also circuitry 58 for converting a probability value to a binary decision, in this embodiment circuitry 58 comprises a random number generator and a comparator.

FIG. 6 also schematically shows a gNodeB which, where the UE 50A is within network coverage, may provide the UE with assistance control information. This may be within a SIB which may include a start or stop determining assistance information toggle command and/or probability value mappings for updating the probability values within data store 57 in user equipment 50A. Alternatively the control signal may be sent as a dedicated RRC signal.

In summary embodiments enable a UE (third-party UE) to provide assistance information on a resource conflict (e.g., a notification on the resource conflict or the resources where the resource conflict is detected) in a resource efficient manner. UE density-based and/or distance-based criteria employed at the UE for triggering the assistance information transmission inhibits too many UEs providing the assistance information on the same resource conflict to a TxUE, which may otherwise result in significant resource wastage. Furthermore, the proposed solution does not require any prior signaling or inter-UE coordination with the TxUE (i.e., between third-party UE and TxUE).

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause An apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
at least one processor; and at least one memory including computer program code, the at least one memory and computer program code being configured to, with the at least one processor, cause:
generating assistance information indicative of a resource conflict detected for a direct transmission from a user equipment; and
determining whether or not to provide said assistance information, wherein said determining whether or not to provide said assistance information in dependence upon at least one of:
a determined received signal power at said apparatus from at least one of said user equipment in a surrounding area;
a determined distance of said apparatus from at least one of said user equipment;
a determined density of user equipment in a surrounding area;
a determined number of user equipment in a surrounding area; and a determined communication activity level of said apparatus, wherein said determining comprises mapping at least one of said determined density, number, or communication activity level to a probability of providing said assistance information, and to provide or not said assistance information in dependence upon said probability.

2. (canceled)

3. The apparatus according to claim 1, wherein said determining comprises determining a probability value to map said at least one of said determined density, number, or determined communication activity level to in dependence upon at least one of:
probability mappings generated at said user equipment;
preconfigured probability mappings stored within said user equipment; probability mappings provided to said user equipment by another user equipment; and
probability mappings provided to said user equipment by a communication network.

4. The apparatus according to claim 3, further configured to following said determining of whether or not to provide said assistance information to determine:
whether other user equipment transmitted said assistance information and to update said probability mappings accordingly.

5. The apparatus according to claim 1, further configured to, following determining not to provide said assistance information for a detected resource conflict to determine whether said user equipment have resolved said detected resource conflict and where not to update said probability mapping for at least one of: providing said assistance information for said detected resource conflict and providing said assistance information for a future detected conflict.

6. The apparatus according to claim 1, wherein said determining a number or density of user equipment in said surrounding area is by at least one of:
a sidelink channel busy ratio CBR;
a number of detected transmissions;
a number of physical sidelink feedback channel PSFCH occupied resources; a number of detected post-collision indications; or
a number of detected transmitting and receiving user equipment pairs within a surrounding area.

7. The apparatus according to claim 1, said apparatus being further configured to:
detect a resource conflict.

8. The apparatus according to claim 7, wherein in response to said detecting a resource conflict detecting multiple conflicts in a same resource, said determining comprises determining whether or not to provide said assistance information for each of said detected conflicts.

9. The apparatus according to claim 8, wherein in response to said determining comprising determining to provide said assistance information to a plurality of user equipment, said apparatus is configured to multiplex a plurality of said assistance information into one message, said one message being transmitted by broadcasting or groupcasting said one message.

10. The apparatus according to claim 1, responsive to a stop determining indication received from a communication network to stop determining whether or not to provide said assistance information and is further responsive to a start determining indication to restart determining whether to provide said assistance information or not.

11. The apparatus according to claim 1, wherein said apparatus comprises a user equipment.

12. (canceled)

13. A method comprising:
in response to an indication that a resource conflict has been detected for a direct transmission from a user equipment;
determining whether or not to provide assistance information indicative of said detected resource conflict in dependence upon at least one of:
a determined received signal power at said apparatus from at least one of said user equipment in a surrounding area;
a determined distance of said apparatus from at least one of said user equipment;
a determined density of user equipment in a surrounding area;
a determined number of user equipment in a surrounding area; and
a determined communication activity level of said apparatus, wherein said determining comprises mapping at least one of said determined density, number, received signal power, distance or communication activity level to a probability of providing said assistance information.

14. (canceled)

15. A non-transitory computer readable medium comprising a computer program comprising computer readable instructions which when executed by a processor are operable to control said processor in response to an indication that a resource conflict has been detected for a direct transmission from a user equipment, to determine whether or not to provide assistance information indicative of said detected resource conflict in dependence upon at least one of:
a determined received signal power at said apparatus from at least one of said user equipment in a surrounding area;
a determined distance of said apparatus from at least one of said user equipment;
a determined density of user equipment in a surrounding area;
a determined number of user equipment in a surrounding area; and a determined communication activity level of said apparatus, wherein said step of determining comprises mapping at least one of said determined density, number, received signal power, distance or communication activity level to a probability of providing said assistance information, and;
generating a control signal indicating whether to provide or not said assistance information in dependence upon said probability.

16. The method according to claim 13, wherein said method further comprises: generating said assistance information.

17. The method according to claim 13, wherein said determining comprises determining a probability value to map said at least one of said determined density, number, received signal power, distance or determined communication activity level to in dependence upon at least one of:
probability mappings generated at said user equipment;
preconfigured probability mappings stored within said user equipment;
probability mappings provided to said user equipment by another user equipment; and
probability mappings provided to said user equipment by a communication network.

18. The method according to claim 13, wherein said method comprises after determining whether or not to provide said assistance information determining whether other user equipment transmitted said assistance information and updating said probability mappings accordingly.

19. The method according to claim 13, wherein said method comprises after determining not to provide said assistance information for a detected resource conflict determining whether said user equipment have resolved said detected resource conflict and where not updating said probability mapping for at least one of: providing said assistance information for said detected resource conflict and providing assistance information for a future detected conflict.

20. The method according to claim 13, wherein said determining comprises determining a number or density of user equipment in said surrounding area by at least one of:
a sidelink channel busy ratio CBR;
a number of detected transmissions;
a number of physical sidelink feedback channel PSFCH occupied resources;
a number of detected post-collision indications; or
a number of detected transmitting and receiving user equipment pairs within a surrounding area.

21. The method according to claim 13, wherein said method further comprises: detecting a resource conflict.

22. The method according to claim 21, wherein in response to detecting multiple conflicts in a same resource, said method determines whether or not to provide said assistance information for each of said detected conflicts.

23. The method according to claim 22, wherein in response to determining to provide said assistance information to a plurality of user equipment, said method multiplexes a plurality of said assistance information into one message and transmits said one message by broadcasting or groupcasting said one message.

24. The method according to claim 21, wherein said method detects a resource conflict by at least one of detecting: reservations of resources for future transmissions, and determining said resource conflict in response to detecting overlapping reservations; a transmitting user equipment transmitting to a receiving user equipment that is itself currently transmitting.
